(19) United States
(12) Patent Application Publication
(10) Pub. No.: US 2009/0282123 A1
(43) Pub. Date: Nov. 12, 2009

(54) Peer shared server event notification system and methods

(76) Inventor: Stefano Fornari, Piacenza (IT)

Correspondence Address: GERALD B ROSENBERG;NEW TECH LAW, 260 SHERIDAN AVENUE, SUITE 208, PALO ALTO, CA, 94306-2009, US

(21) Appl. No.: 12/151,831

(22) Filed: May 9, 2008

(51) Int. Cl. G06F 15/173; G06F 15/16

(52) U.S. Cl. 709/207; 709/239; 709/224; 709/204

(57) ABSTRACT

Peer-communicated notices of requested actions are distributed to mobile devices on routing incompatible networks. A peer management server receives action requests for mobile devices communicated from a plurality of routing incompatible networks. In response to an action request, as received from a first mobile device, a set of one or more peer-shared notices are determined for delivery to a set of second mobile devices coupled to the same routing incompatible network. Selection of the deliverable notices is dependent on a policy identifier associated with the first mobile device. The set of notices are sent to said first mobile device for relay distribution to said set of second mobile devices utilizing the communications channel preferably as established by the first mobile device in communicating the action request. Delivery confirmation of individual peer relayed notices is preferably obtained upon receipt of an action request from the corresponding second mobile devices.

### BACKGROUND OF THE INVENTION

1. Field of the Invention

The present invention is generally related to mobile communications systems and, in particular, a peer-based event notification system enabling distribution of event notices across routing incompatible network communications systems.

2. Description of the Related Art

Mobile, characteristically wireless communications devices have been widely adopted as distributed application platforms. Conventional distributed applications include e-mail, shared contact lists, calendaring and scheduling, instant messaging, Web browsing, and other typically group-ware oriented applications now in common use, as well as a growing collection of generally commercial, including news and shopping-oriented, services. These distributed applications typically employ client application components locally executed on individual mobile devices and a remote or server executed application. Growth in frequency of use and reliance by users as well as a continued diversification in the nature and function of applications is expected to only increase. In addition, the operational capabilities of mobile devices, ranging from small digital pagers to and beyond the current highly functional Blackberry™ and iPhone™ devices is expected to expand to support increasingly more complex distributed tasks and applications.

A historical consequence of the growth in mobile device technologies has been the concurrent development of a large number of different, often competing communications systems and protocols available for use by these devices. Combined with the existing segmentation of the telecommunications marketplace, mobile devices and the service plans offered by or on behalf of different network operators tend to control, from a commercial perspective, how participating devices are managed and the services and applications that may be accessed by the devices. In many if not most instances, differences in communications systems, protocols, services plans, and mobile device variants are a product of an evolving competition between maturing technologies and commercial strategies. Differences have and will continue to arise from incidental choices made among competing technological alternatives at different times by the various mobile device manufacturers, communications network operators, and related supporting service providers. As a consequence, aside from standard voice services, a few more broadly standardized extended services, such as short messaging services (SMS), and contractually allied services, such as for example, iTunes® client applications, the different communications networks maintained by network operators and service providers are essentially isolated from one another and closed to independent service providers.

One area of particular growth related to mobile devices is in the development and use of proprietary distributed applications. Similar to the general availability distributed applications, proprietary distributed applications employ proprietary client executed application components that communicate with a remote or server executed application. A proprietary distributed application is characteristically an alternate, or customized implementation of a general use group-ware oriented applications or otherwise a dedicated application specific to or controlled by some particular company or enterprise.

While access to and use of proprietary distributed applications might be desirably implemented and controlled by an application service provider independent of a network operator, the functional closure of the networks essentially precludes such independent access. For general availability distributed applications, the network operator, network dedicated service provider, or a third-party value-added service provider retained by the network operator will host the server applications. Dedicated or hosted distributed application servers will be established either within or connected through the mobile switching center servers (MSC-S) dedicated to managing operation of a particular mobile device communications network. These captive applications are allowed access to and utilization of the Mobile Subscriber ISDN Number (MSISDN) and related information effectively maintained internally by the network operator in management of the mobile device communications network. Such access and use is entirely subject to network operator defined and managed controls.

To enable operation of proprietary applications, otherwise independent application providers must actively work with the network operators to obtain communications network support for their proprietary distributed applications. Group-ware oriented distributed applications frequently have the need if not requirement for the application server to push information to participating client application components. Often, the timeliness of these push notices will control the perceived if not actual performance and commercial effectiveness of the application. An interoperation of MSC-S and proprietary application servers is therefore conventionally required to enable the application server to locate and communicate, as required, with participating mobile devices. Even where the general population of mobile devices managed by a network operator will have no access to a proprietary distributed application, or visibility that such an application is supported by a network operator, the burden of establishing, managing, and maintaining the service interoperability connection remains on both the network operator and each independent service provider.

Distributed applications that are not hosted or explicitly endorsed, such as through the establishment of a third-party value-added service provider relationship, are severely disadvantaged if not entirely blocked. In many cases, such externally hosted applications, even though particularly desired or required by business and other interests, may be viewed as commercially inconsequential by the network operator or potentially competitive with the service offerings otherwise available directly through the network operators. In other cases, externally hosted applications may be viewed by a network operator as being too disruptive or new and therefore undesirable for implementation or support by a network operator. Consequently, such externally hosted applications are effectively shut out from use of the various mobile device communications networks or, at best, severely restricted in their ability to effectively interact with mobile devices.

### SUMMARY OF THE INVENTION

Thus, a general purpose of the present invention is to provide an efficient mechanism and methods for the distribution of event notices across and between routing incompatible network communications systems in support of and to functionally enable utilization of proprietary distributed applications for mobile devices independent of network operators.

This is achieved in the present invention by providing a system and methods, implemented by computer, enabling peer-communicated notices of requested actions to mobile devices on routing incompatible networks. A peer management server receives action requests for mobile devices communicated from a plurality of routing incompatible networks. In response to an action request, as received from a first mobile device, a set of one or more peer-shared notices are determined for delivery to a set of second mobile devices coupled to the same routing incompatible network. Selection of the deliverable notices is dependent on a policy identifier associated with the first mobile device. The set of notices are sent to said first mobile device for relay distribution to said set of second mobile devices utilizing the communications channel preferably as established by the first mobile device in communicating the action request. Delivery confirmation of individual peer relayed notices is preferably obtained upon receipt of an action request from the corresponding second mobile devices.

An advantage of the present invention is that the peer-to-peer notification mechanism implemented efficiently enables triggering of actions on remote, typically mobile devices, irrespective of connection of the various devices through incompatibly routed networks. The peer management server, as implemented in accordance with the present invention, operates to monitor network participation by managed devices and to receive and distribute notices through delivery paths appropriate to particular devices.

Another advantage of the present invention is that the peer notification mechanism efficiently utilizes connections initially established by mobile devices to obtain application or other targeted services to independently upload and initiate relay delivery of sets of peer-shared notices utilizing connections established among peer devices, independent of the peer management server, to perform relay distribution of notices. The communications protocol used to upload the peer notices and used in the relay distribution of individual peer-shared notices can each be a different, a local network appropriate communications protocol. Individual protocol selection can be performed, subject to policy, by the peer management server to optimize time and cost effective notice delivery.

A further advantage of the present invention is the establishment of participatory peer-notice communities of mobile devices through which notices can be reliably distributed. Notice relay is preferably performed on a combination of permission and policy that is distributed between the local devices and peer management server. A policy engine adjust to the peer management server records default participation capabilities and preferences, and records participation and performance metrics enabling the peer management server to efficiently distribute notices through participatory mobile devices. Policies local to the mobile devices permit discrete, in terms of locally relevant time and circumstance, modification of the default policies applicable to a mobile device.

Still another advantage of the present invention is that the distribution of notices is transparent with respect to the devices participating in the relay and receipt of notices and with respect to the communications networks utilized by participating notice group members. Relay distribution of notices presents a minimal load determined, by the peer management server, to present a minimal impact on the primary performance of the action initially requested by the mobile device. Further, the policy based selection of notice relay protocol is optimized to minimally impact, if at all, any service cost, bandwidth, and data transport limitations imposed on the mobile device by the network operator.

### BRIEF DESCRIPTION OF THE DRAWINGS

FIG. 1 is a simplified network system diagram illustrating an operating environment wherein preferred embodiments of the present invention may be utilized.

FIG. 2 is a simplified network diagram illustrating the performance of peer-based notification among routing incompatible networks in accordance with a preferred embodiment of the present invention.

FIG. 3 is a block diagram of a preferred embodiment of a mobile network communications device for use in an implementation of the present invention.

FIG. 4 provides a block diagram of a preferred embodiment of a peer management and related application server system for use in an implementation the present invention.

FIG. 5 is a state transition diagram illustrating a preferred peer-based notice distribution flow as implemented in a preferred embodiment of the present invention.

FIG. 6 is a process flow diagram describing the operation of a peer management server in supporting peer-based notice distribution in accordance with a preferred embodiment of the present invention.

### DETAILED DESCRIPTION OF THE INVENTION

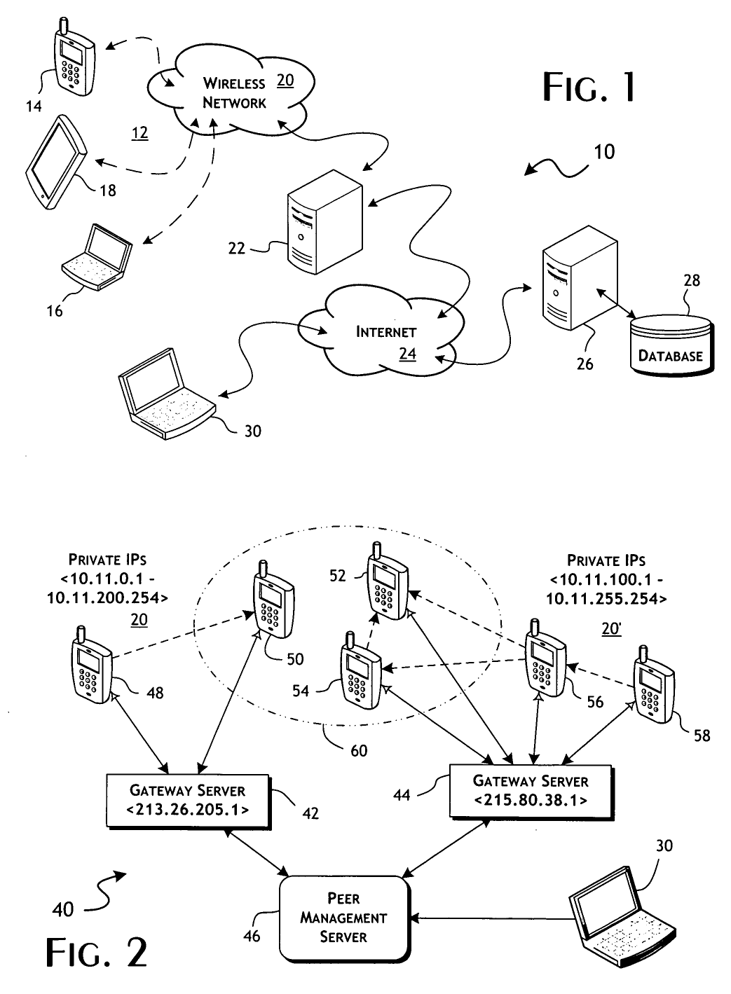

A preferred operating environment 10 of the present invention is shown in FIG. 1. As will become clear from the following detailed description of the invention, wherein like reference numerals are used to designate like parts depicted in one or more of the figures, the present invention functionally enables independent service providers to provide proprietary distributed application services, including delivery of data synchronization notices, to client devices 12, operationally independent of the network operators. With respect to the present invention, proprietary distributed application services include commercial and open-source application services that may be duplicative, competitive with, additive, or independent of the distributed application services provided by a network provider or allied service provider.

In the preferred embodiments, the client devices 12 are typically mobile wireless devices, including cellular telephones 14 and various keyed 16 and pen-based 18 personal information management type computer systems. Communications with the client devices 12 is performed through a wireless network 20, typically cellular in architecture, that is otherwise managed and maintained by a network operator, here generally represented by a network operator system 22. Generalized data communications by the client devices 12, where routed out-of-network, connect through the network operator system 22 typically to the public Internet 24.

An independent service provider of a proprietary distributed application, in accordance with the present invention, establishes an application server 26, including associated database 28, that hosts directly or indirectly the server component of the distributed application. Multiple distributed applications can be concurrently hosted or hosted on other similarly situated servers. These distributed applications can be and preferably are accessible through the Internet 24 by the client devices 12 and conventional computer systems 30 under execution control of a local client component. Characteristically, the server component supports the distributed client components in performing various operations consistent with the function of the proprietary application. In performing these service operations, data affecting, used by, or shared by multiple clients may be altered in some significant manner, typically as determined by the particular nature and function of the server component.

An integral operation of the server component, particularly as implemented in group-ware type distributed applications, is an automated provision of notices to client components. These notices serve to selectively advise the client components of data status changes. A notice may be issued to a client whenever a server operation uses or alters data associated with the client, typically subject to criteria evaluated by the server component to determine the significance of the use or alteration of data. Notices are also issued where the client component invoked function of the server component requires delivery of data to or the performance of an action by another client. As may be appreciated, the form and content of these notices, delivered as electronic messages, are typically specific to a single or suite of distributed proprietary applications.

As recognized by the present invention, the various wireless networks managed by network operators are often established and maintained as routing incompatible networks. As illustrated in FIG. 2, within an environment 40 of multiple wireless networks 20, 20′, network operator server systems 42, 44 operate as connection routing gateway servers to the Internet 24 for the benefit of various connected mobile devices 12. While the network operator server systems 42, 44 present public network interfaces, identified by public domain assigned internet protocol (IP) addresses, the mobile devices 12 within the connected wireless networks 20, 20′ are assigned private IP or equivalent domain addresses. Where private IP addresses are utilized consistent with RFC1918 (Address Allocation for Private Internets; ietf.org), the potential exists for different wireless networks 20, 20′ to actively allocate and rely on overlapping IP address ranges, generally as illustrated. The network operator server systems 42, 44 manage the assignment and reassignment of IP device addresses within the respective networks 20, 20′ and, further, each implement the network address translation (NAT) protocol or an equivalent to internally enable out-of-network routing of connections initiated by the mobile devices 12. Conventionally, the NAT implementations operate to fully conceal the private IP domain namespace, including presence and operation of the mobile devices 12. Without the active participation of the network operator server systems 42, 44, routing of conventional communications connections from outside of the mobile networks 20, 20′ is conventionally precluded. The endpoint IP addresses within the wireless networks are not only hidden, but further subject to change at arbitrary, unannounced intervals. Each of the networks 20, 20′ are thus routing incompatible from the perspective of, or participants within, any other network 20, 20′ and from the Internet 24.

A further complication arises where one or more of the mobile devices 12 are either not enabled to use IP-based communications or due to preferences or other reasons, such as roaming location, IP-based communications is not preferred or allowed. In such instances, only point-to-point communications, such as provided by SMS and similar protocols is possible. While the routing incompatibility of the various networks may not present a barrier to the use of SMS type protocols, the associated per-connection communications cost and resource requirements are such that use of SMS type protocols is generally undesirable.

In accordance with the preferred embodiments of the present invention, a peer management server 46 is operated by an independent service provider to implement and manage the delivery of notice messages to client devices 12 irrespective of whether any particular client device 12 is connected to and thereby only accessible through a routing incompatible network 20, 20′. Further, notice delivery is managed in a manner to dynamically optimize the speed, reliability, cost, and resource requirements involved in the efficient delivery of notice messages, including the use of client mobile devices 12 operating as functionally transparent notice message relays. In particular, delivery paths and protocol choices for the relay of notice messages are balanced against the availability, capabilities, and load capacity of various client mobile devices 12 that could potentially participate in the relay delivery of notice messages.

Preferably, the peer management server 46 hosts, directly or indirectly, a proprietary distributed application and is accessible from the gateway servers 42, 44 through the Internet 24. For purposes of discussion, mobile devices 48, 50 and mobile devices 52, 54, 56, 58 operate in respective routing incompatible networks 20, 20′. Devices 50, 52, 54 are, as shown, associated as part of a notice group 60 at least inferentially defined based on a shared use of a proprietary distributed application hosted by the peer management server 46. A notice event generally occurs whenever an action by a member of a notice group 60, other client 30 executed component, or other event sent to or monitored by the server component is recognized as a condition defined as requiring notice messages be sent to any particular participating devices 48, 50, 52, 54, 56, 58 or one or more potentially overlapping notice groups 60.

In execution of the notice service as required by a proprietary distributed application, the peer management server 46 does not require use of the internal mobile device management and configuration services of the network operator systems 42, 44. Rather, in accordance with the present invention, the peer management server 46 opportunistically utilizes network connections, when and as existing, preferably independent of whether established using an IP-based, SMS, or other communications protocol, to propagate client notices selectively as peer relayed messages to and through the different wireless networks 20, 20′. As illustrated, an existing, typically client initiated connection between a mobile device 48 is dynamically recognized and can then be utilized to relay any pending notice message to other mobile devices, such as mobile device 50, within the same routing incompatible wireless network 20. Where the notice message is directed to a notice group 60 spanning multiple networks 20, 20′, other connections may be required to reach all notice group participants. As shown, a second delivery path connection, through either a member, or non-member mobile device 54,56 of another routing incompatible wireless network 20′ is dynamically recognized and utilized by the peer management server 46 to achieve timely delivery of client notice messages to devices 50, 52, 54. Any number of relay hops may be utilized, as shown in relation to mobile devices 52, 54, 56, 58, regardless of whether any of the participant mobile devices are members of a notice group 60, in order to effect delivery of a notice message within a routing incompatible wireless network 20, 20′.

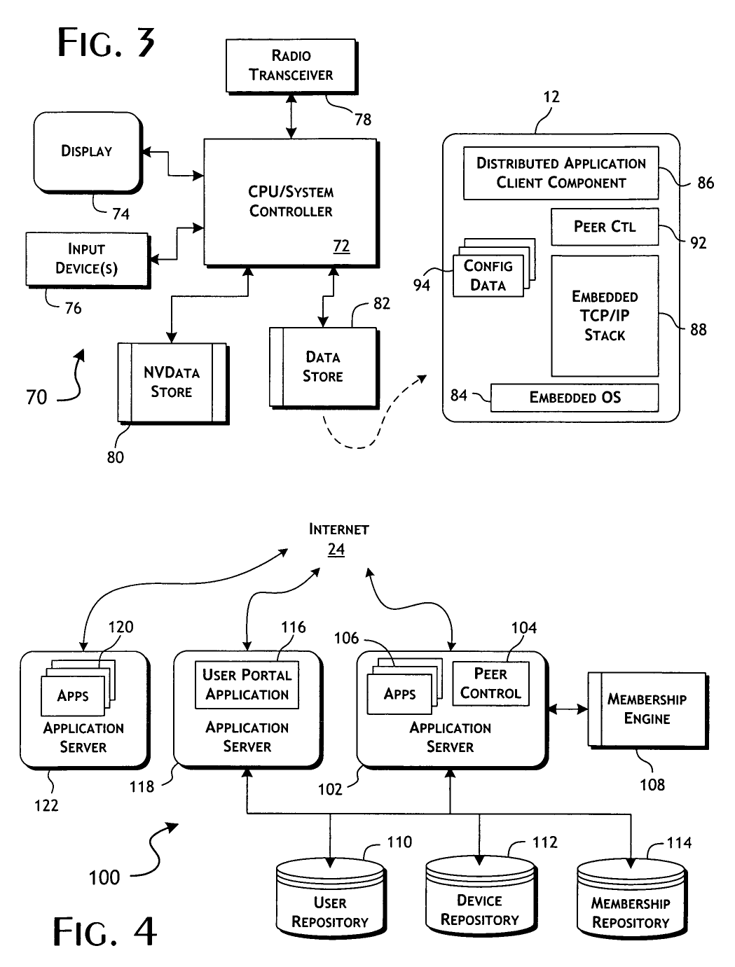

A preferred architectural implementation 70 of a client device 12 suitable for use with the present invention is shown in FIG. 3. The hardware platform includes a conventional embedded processor control system 72 supporting display 74 and input device 76 interfaces. A conventional radio transceiver 78 enables communications with an applicable wireless network 20, 20′. Conventional non-volatile 80 and dynamic 82 random access memories provide local storage for an embedded operating system 84 and one or more distributed client application 86. While the embedded operating system 84 is typically proprietary, a basic, standards compliant TCP/IP protocol communications stack 88 or proprietary functional equivalent is included to support network communications. Where the communications stack 88 is not IP-based, an analogous device addressing system is conventionally used, which will be referred to as an IP equivalent system for purposes of convenience.

Independent of the specific implementation of the communications stack 88, an IP address or equivalent is utilized to individually identify the client device 70 within the applicable wireless networks 20, 20′. The addresses are determined and distributed utilizing a dynamic host configuration protocol (DHCP) or equivalent executed separately by the gateway server systems 42, 44, or otherwise internal to the wireless networks 20, 20′. The IP address assignment is, in effect, performed arbitrarily by a network operator server 22, both in terms of the specific IP address value and the timing of assignments. Conventionally, an IP address will be assigned by the network operator server 22 to a client device 70 each time a client device 70 connects to a wireless network 20. Additionally, network operators are free to assign new network IP to the client device 70 at any time. While reassignments typically occur in response to movements by the client device 70 within the network topology of the wireless network 20, as may be forced by practical network implementation constraints, network address reassignments are ultimately determined based on criteria determined exclusively by the network operator. Conventionally, a client device 70 is required to immediately accept and use the network operator assigned IP address.

A peer controller layer 92 is preferably provided either as an integral element of a client component 86 instance or as a separate common component shared by the one or more different client components 86. In either case, the peer controller layer 92 is preferably responsible for managing interoperations with the peer management server 46. The managed operations include implementation of a peer relay notice transport protocol and storage and enforcement of local policies that selectively supercede general participation policies maintained by the peer management server 46 with respect to the client device 70. These local policies are preferably maintained in a configuration data area 94 of the non-volatile 80 memory store and evaluated locally through execution of the peer controller layer 92. In the preferred embodiments, the peer controller layer 92 is constructed capable of selectively utilizing the communications protocols supported by the communications stack 88, including IP-based, SMS, and other protocols.

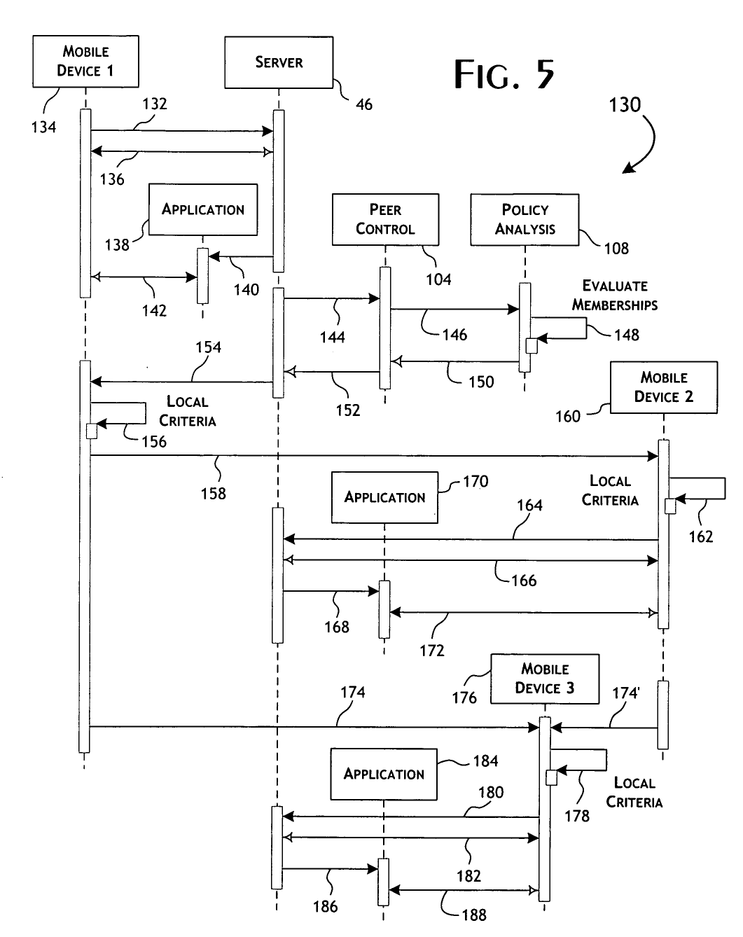

As illustrated in FIG. 4, a peer management server system 46 is preferably implemented as an application server system 100 including a primary application server 102 supporting execution of a peer control application 104 and any number of distributed proprietary server component applications 106. The peer control application is preferably responsible for implementing the peer relay notice transport protocol and managing the associated notice message routing functions. In the preferred embodiments of the present invention, a member ship engine 108, implemented on a separate sever or on the application server 102, operates against user, device, and membership records maintained in persistent database repositories 110, 112, 114 to dynamically resolve available relay routing paths, subject to policy controls, for use by the peer control application 104 in distributing notice messages.

Preferably, one of the applications 106 is a user portal application 116 that supports a collection of Web-based forms allowing for the registration of users for access to the distributed proprietary server applications offered by or through the peer management server system 46. In a preferred embodiment of the present invention, the user portal application 116 is executed on a separate application server 118 to offload the processing burden of the user portal application 116 from the primary peer control application server 102. Preferred user information collected is listed in Table I:

TABLE I
User Information

| Feature | Description |
|---|---|
| User Account | Identification and billing information |
| Membership IDs | Current membership group IDs |
| Application Subscriptions | Identification of use enabled distributed |
| | proprietary applications. |
| Device IDs | Devices associated with user account |
| Participation Level | Length of time participating as a peer relay |

In addition to user registration, the user portal application 116 preferably supports registration of participating mobile devices 12, including the particular operational capabilities and capacities of the mobile devices 12 and relevant details of the service plans that the devices 12 operate under, including data service options subscribed to, usage limits, and related usage and cost criteria. The user can also establish participation or membership in one or more notice groups 60. Preferred device information collected is listed in Table II:

TABLE II
Device Information

| Feature | Description |
|---|---|
| User ID | User identification |
| Device ID | Device identifier |
| Phone Number | MSISDN or equivalent |
| Authentication | User and device authentication data |
| Information | |
| Carrier | Network Operator identification |
| Routing | Proxy routing information, if required |
| Device Type | Identification of the device manufacturer/model |
| Relay Types | Allowable/supported notice message relay |
| | protocols, such as SMS, TCP, proprietary, etc. |
| Participation Policy | Policy controls governing restricted or |
| | unrestricted relay use, restricted use criteria, |
| | hours of relay availability, bandwidth use limits, |
| | etc. |
| Communications Plan | Plan capabilities and limitations, such as |
| | defined hours for unlimited usage, SMS |
| | enabled and restrictions, hours of free use, etc. |
| Participation | A figure of merit reflecting the size and |
| Significance | complexity of dependent membership groups |
| | as an indication of the use of this relay device |
| | in connecting to other groups. |

Additionally, dynamic device related status, use and performance information is accumulated, as detailed in Table III:

TABLE III
Dynamic Device Information

| Feature | Description |
|---|---|
| Public Address | Last reported gateway IP address or equivalent |
| Private Address | Last reported private IP and subnet mask or |
| | equivalent |
| Position | Last reported time zone and, if available, GPS |
| | or other position identifier |
| Activity Level | Last reported on/off status and level of user |
| | initiated usage |
| Performance Capability | Signal strength/bandwidth limitations |
| Participation History | Historical usage data, including number of |
| | notices received, number of notices relayed, |
| | receipt and relay transfer rates, totals, and |
| | total/day, number of different users/devices |
| | relayed to, relay costs incurred and type of |
| | relays performed |

For purposes of the present invention, notice groups 60 are defined inferentially or explicitly in terms of the collaborative use of one or more of the distributed proprietary server applications. For example, a shared calendar application will determine, based on user-defined collaborative groups, the applicable members of a notice group 60 in response to particular calendar dependent events. The distribution list of text message addressees will similarly determine a corresponding notice group 60. Data establishing user-defined collaborative groups and permitting qualification of distribution lists is preferably stored by the user and membership repositories 110, 114.

Notice distribution paths, specifically the allowable mobile devices 12 that may participate in the relay of particular notices use for notice distribution, is separately determinable from the stored 110, 114 user and membership policies. Dependent on the user and membership policies, relay distribution paths may be constrained by common employment or affiliation with a particular company or by a defined degree of separation based on user relationships through a hosted address-book application. Relay distribution may be further constrained on the type and availability of mobile device compatible communications protocols, IP-based, SMS, or other, and the plan-based relative usage costs and limits applicable to potential relay participants. The user portal application 116 can thus determine to whom and through what associated mobile devices 12 particular notice messages may be relayed consistent with all user and group defined policies.

The user portal application 116 may also be used to specify, for users and various groups of users, the preferred or required instances of distributed proprietary server applications that can be used. In the case of clustered or distributed application servers, the peer management server system 46 can manage the relay distribution of notice messages while redirecting access to distributed proprietary server applications 120 executed on remote application servers 122. These remote application servers 122 may be owned by the independent service provider operating the peer management server system 46 or by other independent service providers.

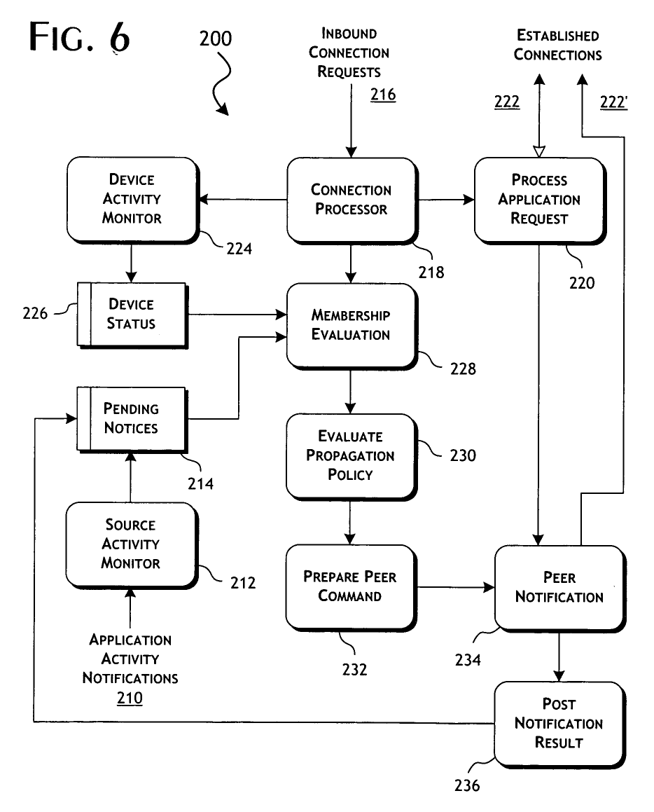

A state transition diagram 130 illustrating a preferred implementation of the peer-based notice relay operation of the present invention is provided in FIG. 5. A peer management server system 46 is established to receive service requests 132 initiated from a mobile device 134. Each service request 132 may be user initiated to access an identified proprietary distributed application, automatically initiated, typically on a periodic basis, by the peer controller layer 92, or automatically initiated in response to a notice message indicating that some action is appropriate with respect to an identified proprietary distributed application. Regardless of the initiator event, the peer management server 46 will use the open communications channel to interoperate 136 with the peer controller 92 layer to authenticate the device 134 and user and to approve access to an identified proprietary distributed application 138. An application session is established 140 and the mobile device 134 is redirected, as necessary, to access the application 138.

As part of the interoperation 136, the peer management server 46 will collect and update device 134 information in the device repository 112. In preferred embodiments of the present invention, device information, such as listed in Table III, is determined and dynamically updated to the device repository 112. Following from the establishment of the connection 132, the peer management server 46 will evaluate 144 whether the connection 136 can be used for the peer-relay of any outstanding notice messages. The peer control application 104, in response to the ongoing operation of the distributed proprietary applications 106, 116, 120, will accumulate an internal list of pending notice messages. These pending notice messages are presented 146 to the policy analysis and membership engine 108 for evaluation 148. In the preferred embodiments of the present invention, the membership engine 108 operates to initially determine whether the mobile device 134, through the currently active connection 136, can be used for the peer-relay of notice messages to other mobile device in the same network 20, 20′. This evaluation 148 is made by determining whether a notice message destination mobile device is potentially reachable through the mobile device 134. A peer-relay path exists where each device in the path is in the some wireless network 20, 20′, a mutually acceptable communications protocol exists for each leg of the path, and each path participant is available for use as a peer-relay based on the user and group corresponding established peer-relay policy criteria stored by the peer management server 46.

On evaluation 148, multiple concurrently active connections to mobile devices in the same network 20, 20′ may be available for use. The membership engine 108 further operates to evaluate the peer-relay policy criteria to determine a relatively optimum choice of mobile device and protocols to be used in the delivery of each potentially deliverable notice message. Thus, as between mobile devices that are capable of performing a notice message peer-relay, the membership engine 108 will balance such factors as explicit membership group relation, policy defined privacy restrictions, service plan defined cost of delivery, current activity level of the mobile devices, historical and short-term levels of relay usage, and signal levels to dynamically decide a best routing of a notice message. Each routing decision is returned 150 to the peer control application 104, which directs 152 the issuance of the notice message. As shown, the notice message is issued 154, opportunistically using the established connection 136, to the mobile device 134 and specifically directed to the peer control layer 92 for redirection relay to the intended destination mobile device, directly or routed through the peer control layer 92 of another peer-relaying mobile device.

In the preferred embodiments of the present invention, upon receipt of a peer-relay notice message, the peer control layer 92 will evaluate local peering policy criteria 156 to determine whether to perform the peer-relay of the notice message. These policy criteria 156 allow a user to automatically or manually disable or restrict participation in the peer-relay of notice messages. Automatic controls may reflect a choice to prevent participation whenever the user is active in a particular distributed proprietary application or when remaining battery life is below a set threshold. Manual controls may be invoked for any user pertinent reason. In the preferred embodiments, the mobile device 134 provides no indication to the peer management server 46 of whether the notice message is relayed or not. The peer management server 46 will, however, eventually recognize that delivery of the notice message through the mobile device 134 was not successful and subsequently factor the success rate into the criteria considered by the membership engine 108.

Where permitted by the local peering policy criteria 156, the mobile device 134, in response to the peer control layer 92, will attempt to establish a connection 158 with the destination, or any intermediary, mobile device 160, identified by the peer-relay notice message. In the preferred embodiments of the present invention, if the mobile device 160 is unavailable, the notice message is simply dropped. Otherwise the message is delivered to the peer control layer 92 of the mobile device 160 for consideration against the local peering policy criteria 162 maintained by the mobile device 160. Where the mobile device 160 is the notice destination, the policy criteria 162 will determine if the mobile device 160 will immediately respond to the notice, defer responding for some period of time, or defer indefinitely by functionally dropping the notice message.

When the mobile device 160 determines to respond, a communications channel will be initiated 164 by the mobile device 160 and used 166 to establish an interoperation between the mobile device 160 and peer management server 46. The peer management server 46 may then qualify and establish 168 a session with a proprietary distributed application 170 and further redirect the mobile device 160 for access 172.

As illustrated, a notice message may be peer-relayed through a connection 174 established by mobile device 134 to a mobile device 176 or a connection 174′ established by mobile device 160, or possibly both. Any number of peer relays may be involved in the successive transfer of a particular notice message. Where the peer management server 46 has received no connection from the mobile device 176 after having provided a notice message for relay through mobile device 134, the active connection 166 with mobile device 160 may be utilized to attempt to resend the notice message through the connection 174′. Depending on the plan cost of sending the notice messages through either or both the mobile device 134, 160, the membership engine 108 of the peer management server 46 preferably adjusts the frequency and routing of repeated notice messages to minimize and balance the delay in ultimately delivering a notice message to the mobile device 176 with the message delivery costs.

Once a notice message has been received 174, 174′ and the peer control layer 92 determines to respond 178, the mobile device 176 will initiate communications 180 with the peer management server 46. As part of the interoperation exchange between the peer management server and peer control layer 92 of the mobile device 176, a distributed proprietary application is identified, a corresponding session established 186, and the mobile device redirected to communicate 188 with the designated distributed proprietary application.

In accordance with the present invention, reports of peer-relay participation can be returned by the mobile devices 134, 160, 176 to the peer-management server 46 at various operating points. Preferably, participation data, identifying both notice messages received and peer-relayed notice messages, is accumulated by the mobile device 134, 160, 176. This collected participation data preferably details successful and unsuccessful relay notice deliveries and refusals to participate due to local criteria restrictions. The collected participation data is transferred to the peer-management server 46 whenever the mobile device 134, 160, 176 subsequently connects to the peer-management server 46. Alternately, a mobile device 134, 160, 176 can initiate a connection to the peer-management server 46 each time the mobile device 134, 160, 176 completes a peer-relay transfer of a notice message. As received, the participation data is recorded in the device repository 112 for subsequent use by the membership engine 108.

The operative process flow 200 of the peer management server 46, as implemented in a preferred embodiment of the present invention, is shown in FIG. 6. The distributed proprietary server applications 106, 116, 120 will generate and issue application activity notifications 210 to a source activity monitor 212 executed on the peer management server 46. These application activity notifications 210 represent application specific determinations that client components 86 are to be notified of some event, typically a change in a data record, that may be of interest to or require an action by the client component 86 directly or in conjunction with the user of the client device. The application activity notifications 210 identify the source application and the device that is to receive the notice. The source activity monitor 212 processes each application activity notification 210 to associate the notice with user and device identifications, storing the resulting notification messages in an internal pending notice list 214.

Inbound connection service requests 216 are separately received by the peer management server 46 by a connection processor 218. On authentication of the device, the connection service request is then processed 220 to establish an interoperative connection 222 to authenticate the user and then identify and evaluate access to a requested proprietary distributed application. Relevant dynamic information, such as the MSISDN and the current public and private addresses of the mobile device are determined 224 and stored 226 by the peer management server 46. Client relay participation data is also preferably collected and stored 226.

Preferably, as new connections are established 222 with the peer management server 46 and as new notice messages are added to the pending notices list 214, the membership evaluation engine 108 is executed to evaluate 228 the potential for a peer-relay delivery of a notice message. As routed paths are identified, usage policies 230 are evaluated to determine whether paths are permitted and, where multiple potential paths are possible, an election of an optimum path based generally on minimizing cost and perceptible burden on the peer-relay mobile devices and likelihood of successful delivery balanced with a desired to distribute costs and load. Once a routed path is determined for a notice message, a peer command containing the notice message including path routing information is prepared 232 and issued 234. The notice message is sent using an existing established connection 222′.

After the notice message has been issued 234, the notice message as stored 214 is marked 236 as pending response, preferably with a last issuance timestamp, issuance count, and the selected routing. On subsequent executions of the membership engine 108, the timestamp, count, and last routing can be considered in the evaluation 228, 230 in determining whether to reissue the notice message and to preferentially select a different routing.

As connections are subsequently established 222, the connecting device and, optionally, an identification of the service requested distributed proprietary application, are associated 234, if possible, with previously issued notice messages. The notice message as stored 214 is then marked 236 as completed, again preferably with a completion timestamp, and recorded in the device repository 112. The performance history associated with the peer-relay mobile devices utilized in the last routing of the issued notice message are also updated as successfully participating in the delivery of a notice message.

Thus, an efficient system and methods for the distribution of event notices across routing incompatible network communications systems in support of and to functionally enable utilization of proprietary distributed applications for mobile devices independent of network operators has been described. In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A method, implemented by computer, of communicating notices of requested actions to mobile devices on routing incompatible networks, said method comprising the steps of:
a) receiving, by a peer management server, action requests for mobile devices communicated from a plurality of routing incompatible networks;
b) determining, by said peer management server in response to a first action request from a first mobile device coupled to a first routing incompatible network, a set of notices for delivery to a set of second mobile devices coupled to said first routing incompatible network dependent on an identifier of said first mobile device;
c) sending said set of notices to said first mobile device for relay distribution to said set of second mobile devices; and
d) confirming delivery of a notice, of said set of notices, upon receipt of a second action request from a corresponding mobile device, of said set of second mobile devices.

2. The method of claim 1 wherein said first action request is received through a communications channel established between said first mobile device and said peer management server, wherein said first action request is transmitted to said peer management server to perform a defined operation, and wherein said step of sending provides for the sending of said set of notices to said first mobile device through said communications channel independent of said defined operation.

3. The method of claim 2 further comprising the step of establishing notices of requested actions for distribution to said plurality of routing incompatible networks, said step of establishing including associating notices of requested actions with respective said routing incompatible networks pending selection, in said step of determining, for inclusion in said set of notices.

4. The method of claim 3 wherein said step of determining includes evaluating, by a policy evaluation engine, defined criteria for determining said set of notices for deliver to said set of second mobile devices.

5. The method of claim 4 wherein said defined criteria conditionally includes technical and community policies and wherein said defined criteria are associated with mobile device identifiers.

6. The method of claim 5 wherein said community policies are qualified by community policies

7. A peer-management server system enabling collaborative interoperation among a plurality of mobile devices accessible through a plurality of routing incompatible networks managed through network operator servers, said peer-management server system comprising:
a) a pending notice queue providing for storage of notice messages representing collaborative application events;
b) a mobile device monitor responsive to connections initiated by a plurality of mobile devices, said mobile device monitor being operative to determine mobile device connection data from connections with said plurality of mobile devices, said mobile device monitor providing for the storage of said mobile device connection data in a data store; and
c) a connection processor, coupled to said pending notice queue and said data store, operative in response to a connection from a predetermined mobile device to select a notice message from said pending notice queue for peer-relay through said predetermined mobile device.

8. The peer-management server system of claim 7 wherein said connection processor includes a notice message propagation policy evaluation engine, wherein said data store further provides for storage of respective policies for said plurality of mobile devices, wherein each said policy defines a plurality of propagation constraints determinative of participation availability for the peer-relay of notice messages, and wherein said notice message propagation policy evaluation engine is operative to determine a propagation path, subject to said pluralities of propagation constraints, to a predetermined mobile device identified by said notice message beginning through a connected one of said plurality of mobile devices.

9. The peer-management server system of claim 8 wherein said connection processor monitors, through connections from said plurality of mobile devices, for notice message delivery, wherein on indication of notice message delivery, said connection processor removes said notice message from said pending notice queue.

10. The peer-management server system of claim 9 wherein said indication is a connection from said predetermined mobile device within a predetermined period of time, wherein in the absence of said indication, said connection processor is operative to re-select said notice message from said pending notice queue.

11. The peer-management server system of claim 10 wherein each of said plurality of mobile devices implement optionally implements local propagation constraints determinative of participation in the peer-relay of notice messages.

12. The peer-management server system of claim 11 wherein said mobile device connection data includes frequency of participation as a peer-relay, success rate in the peer-relay delivery of notice messages to other of said plurality of mobile devices, local protocols available for use in the peer-relay of notice messages, and cost factors related to peer-relay of notice messages, and wherein said connection processor is operative to evaluate said mobile device connection data in determining a peer-relay delivery path for said notice message that balances overall load on said plurality of mobile devices while optimizing the successful delivery rate of peer-relayed notice messages.

13. The peer-management server system of claim 12 wherein said mobile device monitor determines mobile device connection data, including a network address for each of said plurality of mobile devices, independent of said network operator servers, wherein said peer-relay delivery path, including a set of mobile device network addresses, is provided with said notice message.

14. A method, implemented by computer, of enabling collaborative interoperation of mobile devices connected within a plurality of mutually routing incompatible networks, said method comprising the steps of:
a) accumulating, in a peer-management server external to said plurality of mutually routing incompatible networks, connection data for each of a plurality of mobile devices, wherein said connection data is respectively determined by said peer-management server in response to connections from said plurality of mobile devices to said peer-management server;
b) maintaining, in said peer-management server, a plurality of server-based participation policies, associated with respective connection data, for said plurality of mobile devices, each said participation policy including propagation controls determinative, for said peer-management server, of the participation availability of said plurality of mobile devices in the peer-relay of notice messages; and
c) delivering, by said peer-management server, a notice message generated in response to a shared-application operation performed by a first mobile device, wherein said step of delivering is performed by:
i) first determining a first predetermined mobile device of said plurality of mobile devices to receive said notice message;
ii) second determining a predetermined one of said routing incompatible networks through which said predetermined mobile device connects;
iii) waiting for a connection from a second predetermined mobile device of plurality of mobile devices to connect to said peer-management server from said predetermined one of said routing incompatible networks;
iv) third determining, dependent on respective said server-based participation policies, a peer-relay delivery path through said second predetermined mobile device to said first predetermined mobile device; and
v) providing said notice message to said second predetermined mobile device for peer-relay to said first predetermined mobile device.

15. The method of claim 14 wherein said peer-management server is operative to determine and update said connection data with the network addresses of the respective ones of said plurality of mobile devices, and wherein network addresses are provided with said notice message for each of said mobile devices in said peer-relay delivery path.

16. The method of claim 15 wherein said plurality of mobile devices report a status of participation in the peer-relay of notice messages and wherein, in said third determining step, the participation success rate of said plurality of mobile devices is considered in determining said peer-relay delivery path.

17. The method of claim 16 wherein said server-based participation policies define controls on the frequency of participation as a peer-relay, local protocols available for use in the peer-relay of notice messages, and cost factors and cost controls related to peer-relay of notice messages, and, optionally, identified subgroups of said plurality of mobile devices allowed for the peer-relay of notice messages, and wherein, in said third determining step, said server-based participation policies are considered in determining said peer-relay delivery path.

18. The method of claim 17 wherein said notice message identifies said first predetermined mobile device and wherein, in response to receipt of said notice message by said first predetermined mobile device, said first predetermined mobile device establishes a connection with said peer-management server.

19. The method of claim 18 further comprising the step of evaluating, local to each of said plurality of mobile devices, respective local participation policies, wherein said respective local participation policies are selectively determinative, independent of said server-based participation policies, of whether a corresponding one of said plurality of mobile devices will accept receipt of notice messages for peer-relay.

20. The method of claim 19 wherein said local participation policies include criteria defining the timing of participation in the peer-relay of notice messages and battery power remaining threshold.
